(19) United States
(12) Patent Application Publication
(10) Pub. No.: US 2017/0039622 A1
(43) Pub. Date: Feb. 9, 2017

(54) GARMENT SIZE RECOMMENDATION AND FIT ANALYSIS SYSTEM AND METHOD

(71) Applicant: METAIL LIMITED, London (GB)

(72) Inventors: Yu CHEN, London (GB); Robert BOLAND, London (GB); Jim DOWNING, London (GB); Ray MILLER, London (GB); Gareth ROGERS, London (GB); Joe TOWNSEND, London (GB)

(73) Assignee: METAIL LIMITED, London (GB)

(21) Appl. No.: 15/303,369

(22) PCT Filed: Apr. 13, 2015
(86) PCT No.: PCT/GB2015/051108

§ 371 Date: Oct. 11, 2016

(30) Foreign Application Priority Data
Apr. 11, 2014 (GB) 1406539.5

(51) Int. Cl. G06Q 30/06; H04L 29/08; G06T 19/20; G06T 15/20; G06T 17/00; G06Q 30/02; G06T 11/20

(52) U.S. Cl. CPC G06Q 30/0631; G06Q 30/0201; H04L 67/22; G06T 11/206; G06T 15/205; G06T 17/00; G06T 19/20; G06F 3/04817

(57) ABSTRACT

A computer-implemented garment size recommendation and fit analysis system in which a memory stores a virtual profile or model of an end-user and a processor is programmed to receive an end-user's selection of a garment and to then determine, using a garment fit algorithm, how well that garment will fit the end-user's profile or model, and in which the algorithm is trained on actual sales data.

### BACKGROUND OF THE INVENTION

1. Field of the Invention

This invention relates to a garment size recommendation and fit analysis system. When shopping for garments on a retailer's website, a customer selects a garment; a garment size recommendation and fit analysis system analyses how well a chosen size of garment would fit the customer, and/or recommends to that customer the best fit or size of garment.

2. Description of the Prior Art

Purchasing clothes from online retailers is a rapidly expanding sector. When choosing a garment online, customers can specify a size, but because they are unable to try the clothes, many customers are reluctant to purchase. So sizing uncertainty is a significant dis-incentive to engaging with on-line garment ordering. And if a customer does purchase a garment online, and the garment does not fit well, then the garment may be returned and the customer may well be reluctant to buy online in future from that retailer. The retailer typically pays for the cost of returning the goods and will, once the goods are returned, also have to manually check and re-package them. This is costly. And poor fitting is a real risk: garment size charts are not standardised across different retailers (and sometimes not standardised across different brands carried by the same retailer), with the result that a dress in size 12 from one retailer or one brand might be the same size as a size 10 from a different retailer or a different brand. Current estimates are that return rates for clothes bought online can be as high as 30%—largely because returned clothes do not fit. So on-line garment shopping can be frustrating for users since they cannot place much reliance on the sizing charts provided by the online retailer. This leads to levels of engagement with online garment retail sites that are no as high as they could be. And the experience can be less profitable than it ought to be, from the retailers' perspective.

So at the present time, to try the clothes on, the user must either go to the shop, or must wait for the clothes to be delivered, both of which take time and entail travel or delivery costs. It would be helpful if the user could purchase garments online and with a high level of confidence that the garments will fit well.

Considerable efforts have been made in recent years to provide computer-implemented systems that construct a virtual body model for a user—i.e. a virtual or computer-graphics based model of most (in some cases, all) of user's head and body; such models are ideally meant to accurately portray the user. These systems then provide a collection of virtual garments that, with varying degrees of accuracy, reflect the actual shape and size of a physical garment that can be bought be a user. A garment can be selected by the user and then fitted, or visualised, onto the user's virtual body model. This enables the user to see what the garment would look like; in particular, whether that style of garment suits the user and whether the fit for that specific size of garment is correct. Reference should be made to PCT/GB2012/05036, the contents of which are in their entirety incorporated herein.

### SUMMARY OF THE INVENTION

A first aspect of the invention is a computer-implemented garment size recommendation and fit analysis system in which a memory stores a virtual profile or model of an end-user and a processor is programmed to receive an end-user's selection of a garment and to then determine, using a garment fit algorithm, how well that garment will fit the end-user's profile or model, and in which the algorithm is trained on actual sales data.

This brings several advantages: 1) the size recommendation engine only requires a very small amount of initial training data to make it usable, However, it can be easily refined and updated over time to gradually adapt the body shape groups of garment categories and different garment brands under that retailers; 2) the engine could track changing trends in the behaviour of a retailers' user group; 3) the probabilistic size models learned by this approach can be intuitively visualized and can hence be more helpful in delivering insightful business information (about body shapes, fit preference, etc.) to retailers; 4) the engine works even when good garment size charts aren't available at all, or when the manufactured item deviates from the size chart for some reason

Features of one specific implementation of the invention include the following:
the algorithm is trained on actual sales data from the retailer of that garment in order to adjust the size charts from that retailer.
the sales data includes one or more of: a list of items purchased in an order the size(s) of the garment(s) in the order, the body parameters of the customer, the customer's demographic information, location, and fit preference; whether the garment(s) were kept, returned, or exchanged.
the algorithm is trained using, and updated on, actual, live sales data.
the actual, live sales data for a specific retailer is tracked using a widget or application launched when a customer browses the web retail web site of that retailer.
the algorithm requires a relatively small amount of initial training data to make it usable, but updates over time to adapt to different body shape groups associated with different garment categories.
the algorithm requires a relatively small amount of initial training data to make it usable, but updates over time to adapt to different garment brands under that retailer.
the algorithm tracks trends in consumer purchasing and returns behavior.
the algorithm operates even when good garment size charts of the retailer or the brand are not available.
the algorithm operates when the manufactured item deviates from the size chart.
the algorithm generates a visual plot, such as a scatter plot, showing how measurements associated with a retailer's size charts correlates with customers who bought and kept, or bought and returned, a particular size of garment from that retailer.
the profile or model is specific to the end-user and is derived from one or more of: personal data relating to the user, height; weight; age; body shape; chest/bust, waist and hip measurements; previously bought or liked garments; previous browsing history.
the profile or model is specific to the end-user and hence not a cluster of similar end-users.

Other optional features:
the algorithm compares the virtual profile or model of the end-user with data from the fit-points of the garment retailer's size charts.
   a fit point defines for a given size of garment the measurements for a user that will best fit that garment, such as bust, waist and hips.
   the algorithm uses a fit function for each fit point that is translated into a textual description displayed to the end-user.
   textual descriptions include one or more of: too small, tight, suggested, loose, too large, or equivalent terms.
   the fit function for a specific retailer's size X has a peak positioned at the measurement that corresponds to the best fit.
   the fit function for a specific retailer's size X has a width to indicate fit tolerance and is determined empirically for a specific garment.
   the fit tolerance is determined by an automatic classification scheme based on comparing the image measurements of overlaying garment and body images (either in 2D or 3D) around the relevant fit point area.
   the output of the fit function is a fit score for a fit point.
   the algorithm uses an overall fitting score that is a function of the fit scores on all relevant fit points for the garment.
the algorithm computes the similarity of the end-user's profile or model and the corresponding measurements of one or more (or each) size of a garment by using a distance metric.
   corresponding measurements of one or more (or each) size of a garment are defined in the size charts from the retailer or manufacturer of that garment.
   the distance metric is the Euclidean distance.
   the distance metric is a metric that takes into account correlation between different body measurements, such as the Mahalanobis distance.
   the distance metric is a metric that takes into account that different fit points have different levels of impact on size recommendation, such as the Mahalanobis distance.
the algorithm uses an estimation of the body shape distribution associated with actual sales and returns of each size of a garment and generates a bias to correct the measurement definition in the size chart.
the algorithm uses a K-Nearest Neighbour (KNN) machine learning algorithm
   the KNN algorithm's extrapolation ability is improved by using a prior that dominates in the final prediction only when training instances are sparse.
   the algorithm uses a soft voting and consensus scheme.
the algorithm uses a Bayesian approach to learn probabilistic models for each garment size from observed body measurement data and default (e.g. original) size charts in order to correct the measurement definitions in the size charts.
the default size chart a size chart of an arbitrary well-known brand.
the algorithm tells the customer how well a specific size of an item currently being viewed would fit against their virtual profile/model (e.g. their bust, waist and hips), for example using predefined terms or categories (eg. ‘Close fit’, ‘Suggested fit’ etc).
the algorithm tells the customer how well an item previously purchased fits against their virtual profile/model (e.g. bust, waist and hips), for example using predefined terms or categories (eg. ‘Close fit, Suggested fit etc).
the processor displays an item of a specific size, together with their fitting information (eg. ‘Close fit, Suggested fit etc) with a choose or selection icon (e.g. a tick box) or system (e.g. drag‘n’drop) that, if activated, transfers the or each item into an on-line shopping bag for purchase.
The system is one in which (a) the virtual profile or model is generated from user data; (b) a 3D garment image is generated by analysing and processing multiple 2D photographs of the garment; and (c) the 3D garment image is shown super-imposed over the 3D virtual body model.

A second aspect is a computer-implemented garment size recommendation and fit analysis method in which a memory stores a virtual profile or model of an end-user and a processor is programmed to receive an end-user's selection of a garment and to then determine, using a garment fit algorithm, how well that garment will fit the end-user's profile or model, and in which the algorithm is trained on actual sales data.

### BRIEF DESCRIPTION OF THE DRAWINGS

FIG. 1 is an example of a fit function of a retailer's size 16 garment with respect to a customer's waist measurement. The labels 14, 16, 18 and 20 are the size labels corresponding to the measurement definitions for the lower end (size 14), the peak (size 16), and the upper end (size 18) of the triangular filter, shown in a solid, dark line.

FIG. 2 is a scatter plot of bust and waist distribution of customers who bought and kept a particular size of dresses; scatter plots for dresses sized 8, 10, 12, 14, 16 and 18 are shown. The plots are based on the sales data of a high-street garment retailer recorded by a Metail widget on the consumer's web browsing device. The white circles for each size represent the measurements that the retailer associates with that size. The dark dots represent instances of customers who bought and kept a particular size of dress.

FIG. 3 shows a precision-recall curve on a cross-validation set of 1020 data instances by ranking the confidence scores of the best size recommendation to the query instance in each round robin test. Confidence scores are obtained using the extended KNN algorithm described in Section 3.3 below.

FIG. 4 is a screenshot showing the recommended garment size (shown in the underlined box—i.e. size 10), and how well that size will fit against the customer's bust, waist and hips.

FIG. 5 is a screenshot showing the recommended garment size for a blouse (size 14); it should fit well against both bust, although it would be too large for the waist and a close fit at the hips. The dress is recommended at size 14, and it should fit well against the bust, but again be too large for the waist and a close fit at the hips.

FIG. 6 is a schematic of the overall system, including (a) the customer's client device (e.g. computer browsing the web, with widget implemented as an iFrame), (b) the retailer's web server, connected to a garment database and (c) the garment recommendation and fit analysis system, typically a cloud-based multi-processor computer system, connected to a database that stores all user data, such as users' models or profiles defining their measurements.

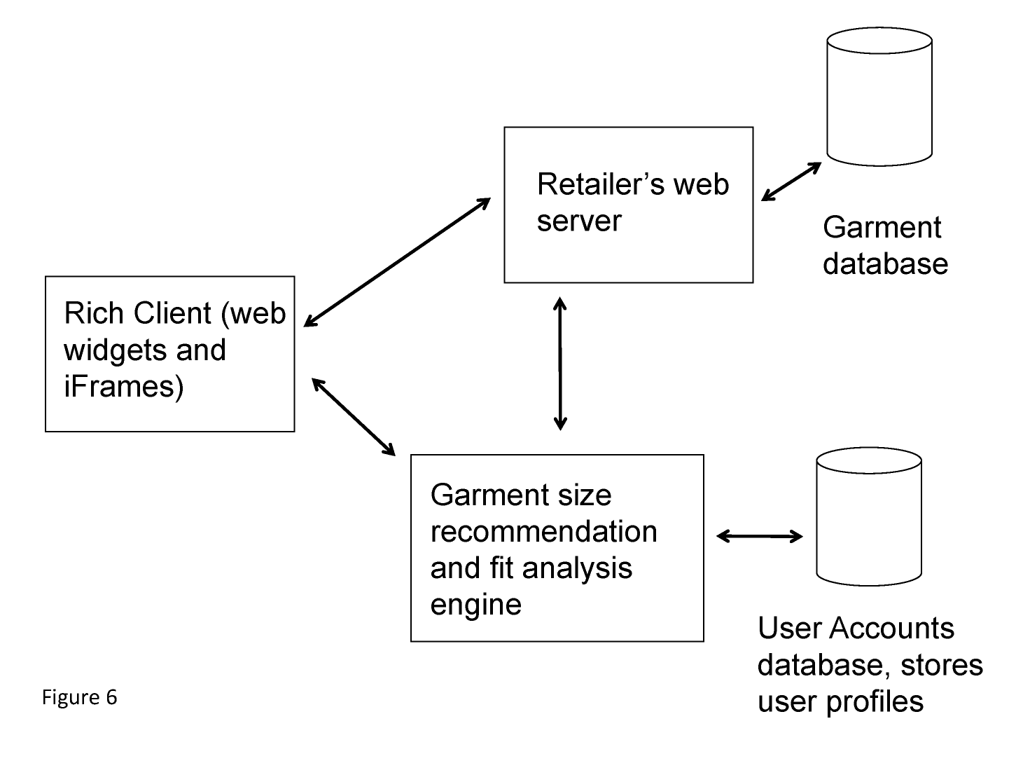

FIG. 7 shows how an automatic classification scheme can be applied to determine the tolerance of the fit points by comparing the image measurements of overlaying garment and body images. In the example, the image of the dress is overlaying on to the image of virtual body model. By comparing the difference of the horizontal measurements at each fit point, we classify the fit points at bust, waist, and hips as “tight”, “Loose”, and “Baggy” respectively.

### DETAILED DESCRIPTION

### 1. Introduction

This section describes the technical details of several algorithms used in an implementation of the invention called the Metail garment size recommendation and fit analysis service. There are two main streams of algorithms:
Fit-point based approaches: including the following methods:
   A heuristic algorithm using fit-points of retailers' size-charts.
   Algorithms based on Euclidean distance metrics algorithm using fit-points of the size-charts.
   Improved heuristic and distance metric approaches using the corrected size-charts estimated from recorded body shape data.
   A Bayesian approach that models the probabilistic distribution characterizing each garment size and recommend size through model selection.
Example-based approaches: an extended k-nearest neighbour algorithm using body shape parameters data and retention data with a size chart prior.

### 2. Approaches Based on Looking Up the Fit Points of the Size Chart

The first stream of approaches we used for size recommendation is based on the fit-points of retailers' size charts. For most size charts, the available fit points are the average bust, waist, hips of the populations who are supposed to fit into the garment of each given size label. For example, on the Tesco clothing size chart in the UK, a size 12 has a bust=93 cm, waist=74 cm, and hips=99 cm, etc.

2.1. A Heuristic Fit-Point Algorithm

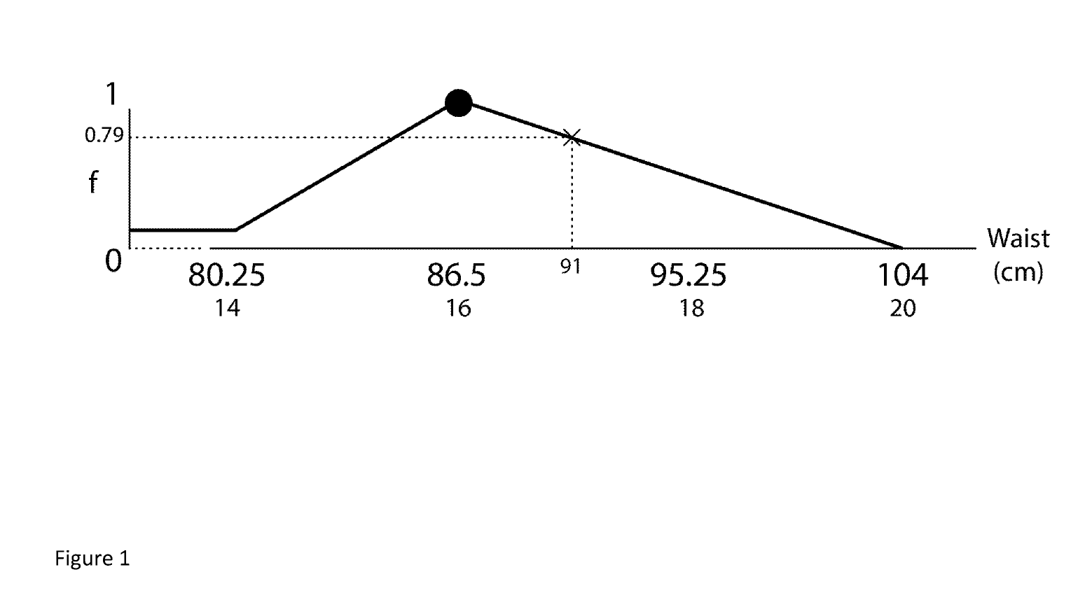

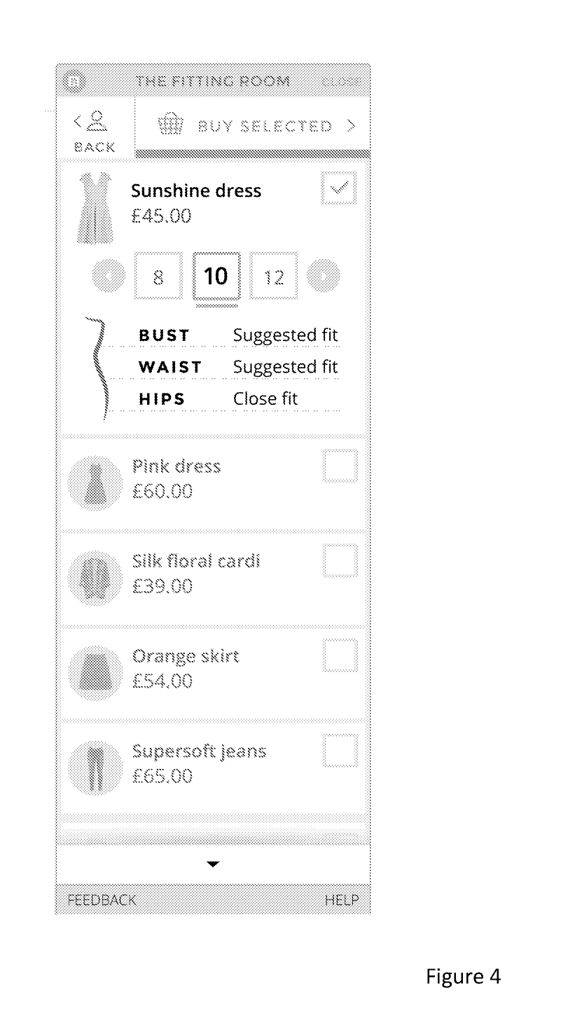

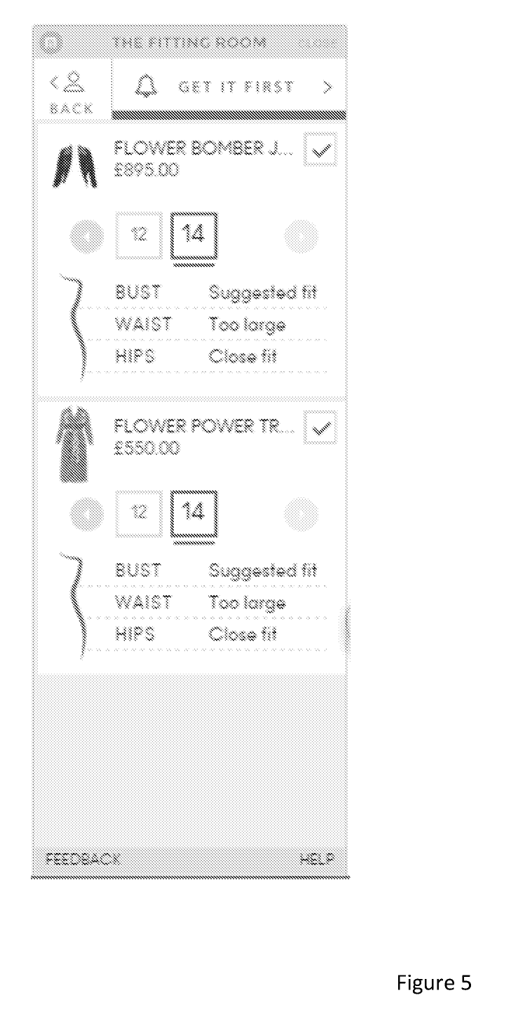

Based on the fit points of the size chart and users' measurement input, we first designed a heuristic algorithm based on an empirical understanding of how a female customer usually thinks the fitting works in a real garment purchase experience. To model how well a particular garment fits the body shape of user, we evaluate a fit-function on each fit point. The fit-function ƒ of a specific size s is defined as a triangular window filter with a output ranged between 0 (doesn't fit) and 1 (perfect fit). See FIG. 1 for an example. The output of the fit-function can be translated into textual descriptions shown to the customer as a fit analysis on the corresponding body part (see Table 1 for an example; FIGS. 4 and 5 show the screen display on the user's web browsing device).

TABLE 1
An example of fit analysis in text descriptions based on the
output of the fit function on the corresponding body part.

| Text Description | Fit value f and body measurement x |
|---|---|
| Too small | f ≦ 0.1 and x < xₚₑₐₖ |
| Tight fit | 0.1 < f ≦ 0.5 and x < xₚₑₐₖ |
| Suggested fit | 0.5 ≦ f ≦ 1 |
| Loose fit | 0.1 < f ≦ 0.5 and x > xₚₑₐₖ |
| Too large | f ≦ 0.1 and x > xₚₑₐₖ |

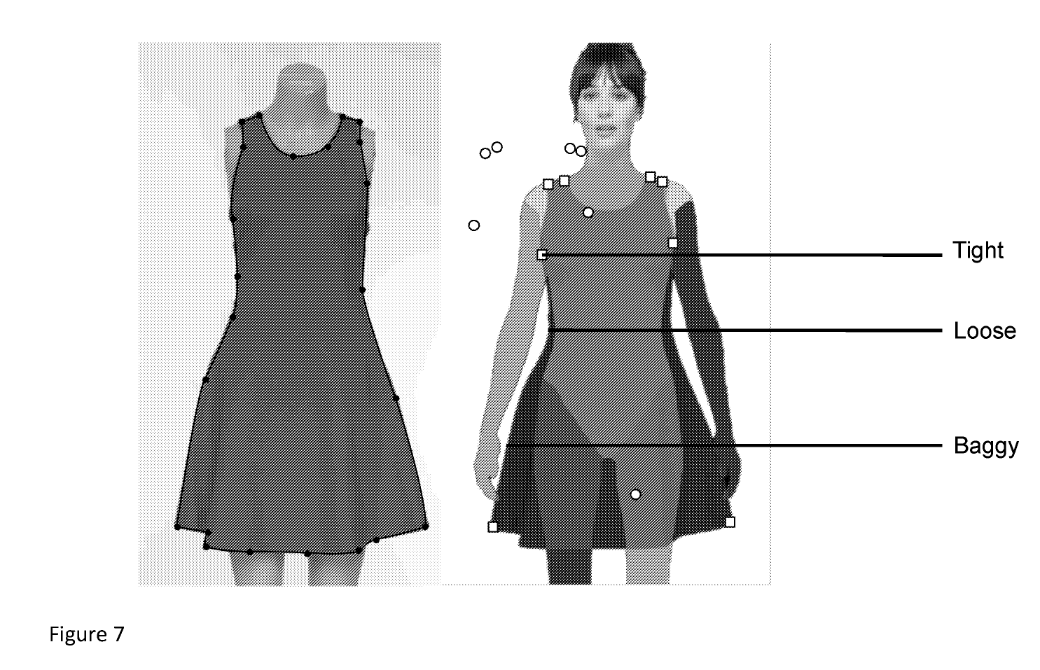

The peak of the fit function is positioned at the measurement definition for the size label s on retailers' size charts. The widths of the window (on both sides) indicate fit tolerance and they are determined for every single garment based on how tolerant the garment is at the specific measurement point for that particular garment based on 1) manual testing and empirical estimation over the garment samples, or 2) an automatic classification scheme by comparing the image measurements of overlaying garment and body images (either in 2D or 3D) around the relevant fit point area (see FIG. 7 for example). This means they vary with the fit style of the specified garment, i.e. wider window widths are assigned to baggy or loose-fitting garments and narrower window widths are assigned for tight-fitting garments. It can also be seen that in FIG. 1, the fit function contains a non-zero constant area on the left side of the triangular window (set to f=0:1 in the implementation), before the filter response reaches zero. This filter design is to characterize the fact that a very small body shape can still fit into a garment of large size, but not vice versa.

The overall fitting score fₒᵥₑᵣₐₗₗ for a particular size s is defined as the product of fit scores on all relevant fit points for the garment. In our algorithm, the relevant set of fit points being used varies with the types of garments as follows.
Dresses: bust+waist+hips;
Tops, shirts and jackets: bust+waist;
Trousers and skirts: waist+hips.

As an example, the overall fitting score ƒ for dresses is

ƒₒᵥₑᵣₐₗₗ(s)=ƒ_{bust}(s)·ƒ_{waist}(s)·βₕᵢₚₛ(s). (1)

This yields a final score between 0 and 1 for each available size s in the size chart S. The best size is given as the one with the highest score:

$${s}^{*} = arg {max}_{s ∈ S} {f}_{overall} ( s ) \qquad ( 2 )$$

For a more general multiple size recommendation, the sizes can be ranked according to the fitting scores in a descendent order.

2.2. An Algorithm Based on a Distance Metric

Another method to recommend a garment size to a particular user, is to compute the similarity between the body measurements x of the customer (mostly including bust, waist, and hips, so usually a 3-D vector) and the corresponding measurement definition m(s) of each size s defined in the size chart S. In mathematics, we need to define a distance metric d(•,•) to evaluate the similarity of two measurements. The shorter the distance, the more similar the two measurements are. The best size can be recommended by the one that yields the shortest distance of measurements.

$${s}^{*} = arg {min }_{s ∈ S} d ( x , m ( s ) ) . \qquad ( 3 )$$

A simple but useful distance metric for garment size recommendation is the Euclidean distance, also known as the sum of squared distance, as the following equation shows.

d_{E}(x,m(s))=∥x−m(s)∥². (4)

This simple distance metric works reasonably well for garment size recommendation. Euclidean distance evaluates the difference on each tape measurement equally and independently. Also, it does not take into account the correlation among different body measurements. In practice, we find that body measurements are usually correlated, e.g. a body shape with a higher than average bust measurement is more likely to also have a higher than average waist measurement, etc. Also, different fit points may have different levels of impact on the size recommendation for different garment types. For example, for tops or t-shirts, fitting on bust is more important than that on waist and hips. Therefore, a better distance metric for size recommendation is Mahalanobis distance, as the following equation shows:

d_{M}(x,m(s))=(x−m(s))^{T}Σ⁻¹(s)(x−m(s)), (5)

where Σ(s) is the covariance matrix of the body measurements for the size label s of the garment. In the case of three measurements: bust, waist, and hips, are used, Σ(s) is a 3×3 matrix. In principle, the covariance matrix Σ(s) may vary with the size and the garment type, and it represents the variation of body shape of the population who buy and keep the particular size s of the particular garment. In practice, Σ(s) can be estimated from the body shape data of customers recorded by the Metail widget (see Section 2.3).

2.3. Size-Chart Adjustment and Covariance Estimation Based on Sales Data

Although the size chart of a garment retailer provides a general guideline for selecting a size, we notice that the body measurements of the actual population group who buy and keep the size could considerably deviate from the measurements specified in the size chart. To give a better estimation on the actual body shape distribution associated with the sales of each size, we looked into the following two sources of data:
The sales records logged down by the Metail widget, which includes the list of items purchased in an order, the sizes of the garment ordered, and the body shape parameters of the customer.
Monthly sale and returns data from the retailers, which tracks down whether each item in the order has been returned by the customer within the previous month.

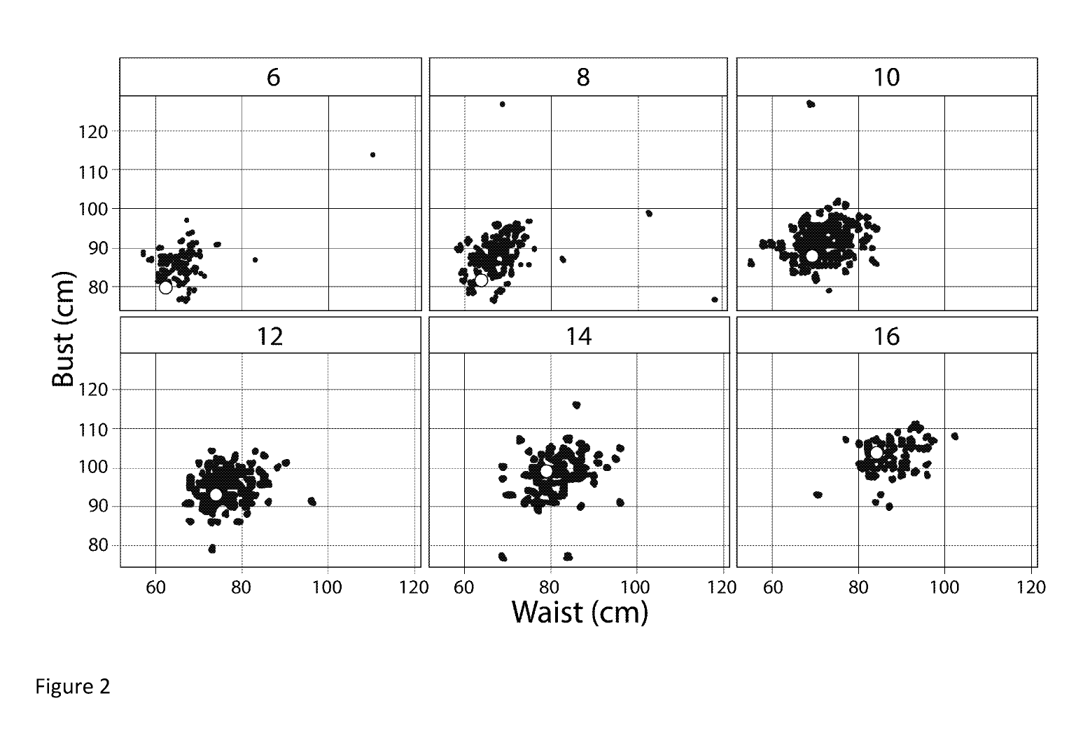

An example of the body shape distribution with respect to garment sizes is illustrated in FIG. 2, in which we plot the bust and waist distribution of customers who bought and kept each size of dress-type garments. The plot is based on the sales data of a high-street garment retailer recorded by the Metail widget between March 2013 and June 2013. The red dots indicate the measurement definition for all sizes of the size chart. We can observe that the actual distribution of the body measurement x of the customers who bought the garment of a particular size s is approximately subjected to a multi-variate Gaussian distribution N (x;μ(s), Σ(s)) except for some outliers. Its mean (i.e. the centroid of the distribution) usually has clear biases from the size chart definitions, ranging from 2.5 to 5 cm. This level of bias can considerably affect the performance of size recommendation. In view of this problem, we attempt to correct the size chart by revising measurement definitions m(s) to the mean of the distribution μ(s) we observed, for each size s defined in the original size chart S as follows:

m′(s)=μ(s)=m(s)+b(s),sεS. (6)

where b(s)=μ(s)−m(s) are the bias vectors to correct the measurement definition on the size chart.

However, in practice, the number of data points we observed are usually insufficient to estimate the bias vector b(s) accurately for each size, especially for some extra small or extra large sizes where the samples are sparse. As an approximation, we correct the size chart using a uniform bias vector b for all sizes, which estimated from all N instances available in the sales records regardless of garment size, as Equation (7) shows.

$$b ( s ) = b = \frac{1}{N} {\sum }_{i = 1}^{N} ( {x}_{i} - m ( {s}_{i} ) ) \qquad ( 7 )$$

where xᵢ refer to the body measurements of the customer i and m(sᵢ)) refer to the size chart measurement definition of the size sᵢ selected by the customer i. The resulting corrected size chart can be used to improve the recommendation accuracy of both the heuristic algorithm (Section 2.1) and the distance-metric-based algorithm (Section 2.2). Furthermore, the estimated covariance matrix of measurement distributions Σ(s) can be used in the size recommendation algorithm based on the Mahalanobis distance (see Equation (5)). Similar to Equation (7), a uniform covariance of measurement Σ can be estimated by Equation (8) when data samples available are sparse:

$$\sum ( s ) = \sum = \frac{1}{N} {\sum }_{i = 1}^{N} ( {x}_{i} - m ( {s}_{i} ) ) {( {x}_{i} - m ( {s}_{i} ) )}^{T} \qquad ( 8 )$$

### 3. Example-Based Size Recommendation

The example-based approach is an alternative solution to the size recommendation approach using the size and body shape data we have gathered from the Metail widget and the sale data from the retailers (see Section 2.3 for further detail). In this section, we describe how we extend the K-nearest neighbours algorithm for the purpose of garment size recommendation.

3.1. K-Nearest Neighbours (KNN) Algorithm

The K-nearest neighbours (KNN) algorithm is a commonly used machine learning algorithm for solving classification and regression problems based on the nearby observed samples. Size recommendation can be considered as a multi-label classification problem. As a mathematical formulation, suppose we have got a total of N training instances in the format of feature-label pair {Iᵢ={xᵢ,Iᵢ}}ᵢ₌₁^{N}, and we have a testing instance I* with known feature x* but with an unknown label In the context of our garment size recommendation problem, “features” are the vectors of body measurements and/or other form of data obtained by transformation or dimension reduction, e.g. BMI, principal components of body shapes etc., while the “labels” are chosen to be vectors of the measurements definitions behind each size label of the garment, and/or other measurements of the garment sizes and stretchiness.

In KNN, we predict the label 1* of I* from its K nearest training instances in the feature space. For the size recommendation, we aggregate out the label of the query as a weighted-average of the labels of all K neighbours:

$${l}^{*} = \frac{{\sum }_{i = 1}^{K} {w}_{i} {l}_{i}}{{\sum }_{i = 1}^{K} {w}_{i}} \qquad ( 9 )$$

where weighting factors wᵢ is a function of distance from the testing instance to each training instance. Here, they are computed as

$${w}_{i} = \frac{{λ}_{i}}{1 + {d ( {x}^{*} , {x}_{i} )}^{2}} = \frac{{λ}_{i}}{1 + {‖ {x}^{*} - {x}_{i} ‖}^{2}} , i = 1 , 2 , … , K , \qquad ( 10 )$$

where d (•) means the Euclidean distance; and λᵢ is the significance value of a data instance, which is used when some data points are more important and hence have higher weights than the others. In the algorithm, we distinguish retention sales from returned sales. For a particular sale, if we find that the item has been returned in a period of time, we discount the influence of the data by setting λᵢ==0.125, while on the other hand we set λᵢ=1 for other retention sales.

When the training instance has exactly the same feature as the testing instance and has not recorded a return, its weight will be 1; on the other hand, when the training instance is getting far away from the testing instances, the weight decreases by distance and close to 0 when the training instance is infinitely far away.

3.2. Encoding a Size Prior to the KNN Algorithm

The regular KNN algorithm described above is purely data-driven. The major drawback of such an algorithm is that its extrapolation ability is quite limited, i.e. when the query instance is the feature space where training instances are sparse, the prediction will be quite unreliable. Concerning such a problem, we propose to encode a size prior of the query instance I*, whose vectors of measurement definitions 1* prior will participate in the weighted average.

$${l}^{*} = \frac{{\sum }_{i = 1}^{K} {w}_{i} {l}_{i} + β {l}_{prior}^{*}}{{\sum }_{i = 1}^{K} {w}_{i} + β} . \qquad ( 11 )$$

In the formula, the new parameter β is a constant weight of the size prior. If β=0, the model is reduced to the basic KNN model. In the implementation, we set β=1. When the query instance is close to many training instances, the instance weights satisfy Σᵢ₌₁^{K}wᵢ>>β, and hence the estimate from the data will dominate over the prior estimate. When the query instance is far away from the training instances, Σᵢ₌₁^{K}wᵢ will be small and hence the prior term dominates and decides the final prediction.

To obtain this size prior 1*ₚᵣᵢₒᵣ, we perform another non-data-driven or non machine learning size recommendation using approaches, e.g. the heuristic fit estimate (Section 2.1) or the distance-metric method (Section 2.2), etc, and transform the output size label into the vector of corresponding tape measurements defined on the size chart.

3.3. Soft Voting Consensus Scheme and Multiple Size Recommendation

Given the query feature vector of the customer, we perform the size recommendation using a soft voting and consensus scheme. Among all K neighbouring training instances, each will give evidence to a range of sizes whose measurement definitions (i.e. the label vectors) are similar to that of instance.

For each size s defined in the size chart, we evaluate the confidence voting weight vᵢ(s) from each nearby instance xᵢ and weight vₚᵣᵢₒᵣ(s) of the prior as follows:

$$\begin{matrix}\begin{matrix}{υ}_{i} ( s ) = \frac{1}{1 + {( l ( s ) - {l}_{i} )}^{T} {\sum }^{- 1} ( l ( s ) - {l}_{i} )} \\ = \frac{1}{1 + {\sum }_{j ∈ \{ bust , waist , hip \}} ( {‖ {l}_{j} ( s ) - {l}_{i , j} ‖}^{2} / {σ}_{j}^{2} )} ,\end{matrix} \\ i = 1 , 2 , … , K , & ( 12 ) \\ \begin{matrix}{υ}_{prior} ( s ) = \frac{1}{1 + {( l ( s ) - {l}_{prior} )}^{T} {\sum }_{prior}^{- 1} ( l ( s ) - {l}_{prior} )} \\ = \frac{1}{1 + {\sum }_{j ∈ \{ bust , waist , hip \}} ( {‖ {l}_{j} ( s ) - {l}_{prior , j} ‖}^{2} / {σ}_{prior , j}^{2} )} ,\end{matrix} & ( 13 )\end{matrix}$$

where 1(s) is the associated garment measurements of size Σ=diag(σ_{bust}²,σ_{waist}²,σₕᵢₚ²) (and Σₚᵣᵢₒᵣ=diag(σ_{bust,prior}²,σ_{waist,prior}²,σ_{hip,prior}²) defines the garment stretching and fitting tolerance on each body dimension. In the implementation, we choose the tolerance radius σ_{bust}, σ_{waist}, and σₕᵢₚ to be 5 cm, 5 cm, and 7 cm respectively, which are average adjacent grading differences based on the size chart. The tolerance radius of the prior is set to be larger σ_{bust,prior}=σ_{waist,prior}=σ_{hip,prior}=10 cm.

Given all the voting weights, the overall confidence score of size s (a value between 0 and 1) is then evaluated as a weighted combination as follows.

$$c ( s ) = \frac{{\sum }_{i = 1}^{K} {w}_{i} {υ}_{i} ( s ) + {βυ}_{prior} ( s )}{K + β} , \qquad ( 14 )$$

where weights wᵢ of instances (i=1, 2, . . . , K) are defined in (10). In the implementation, we found that setting β=2 gives the optimal performance.

This algorithm provides the confidence estimates for all the sizes. To recommend the best size, we return the size sₚᵣᵢₒᵣ with the highest confidence score

$${s}^{*} = arg {max}_{s} c ( s ) . \qquad ( 15 )$$

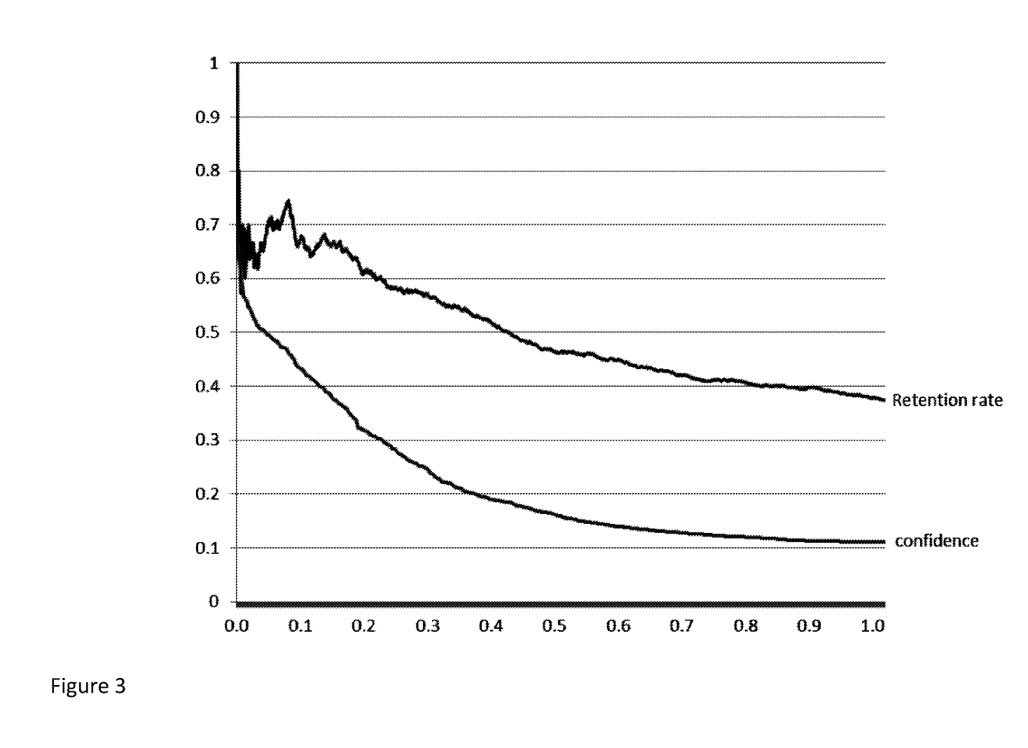

This can be used to easily give multiple size recommendations along with their respective confidence scores. During the experiment, we carried out a cross-validation on a dataset of 1020 instances and in FIG. 3, we plot a precision-recall curve by ranking the confidence score of the best size recommendation to the query in each round robin test. A strong correlation between prediction precision and value of confidence score is indicated.

3.4. A Working Algorithm

Finally, we summarize an end-to-end working extended KNN algorithm for garment size recommendation in Algorithm 1. All the parameters in the algorithm are given explicitly.

Algorithm 1 Extended KNN algorithm for garment size recommendation.

Input: A testing instance I with feature x=[height, weight, chest, bust, waist, his] and garment category gε{dress,top,trousers}; a size chart in the form of a list of size chart entries {1(s)={bust(s), waist(s), hip(s)}, sε{all available sizes}}.

Output: the garment size sₚᵣᵢₒᵣ, the confidence value c between 0 and 1.
1. Compute the size prior sₚᵣᵢₒᵣ using the Euclidean-distance algorithm with a corrected size chart (Section).

$${s}_{prior} = arg {min}_{s} {‖ \hat{l} ( s ) - {l}_{user} ‖}^{2} .$$

where Î(s)={bûst(s), waîst(s), hîp(s)} are the garment measurements of size s defined on the corrected size chart. The garment measurement label prior is given as 1ₚᵣᵢₒᵣ={bust(sₚᵣᵢₒᵣ),waist(sₚᵣᵢₒᵣ), hip(sₚᵣᵢₒᵣ)}.
2. For each instance Iⱼ in the training set that is in the same garment category gⱼ=g and has a feedback score ≧3 (i.e. “probably not return” or “definitely not return”), compute the Euclidean feature distance
3. Pick the K=16 instances with the nearest feature distances, and compute distance weights wᵢ of each instance i with

$${w}_{i} = \frac{{λ}_{i}}{1 + {d ( {x}^{*} , {x}_{i} )}^{2}} = \frac{{λ}_{i}}{1 + {‖ {x}^{*} - {x}_{i} ‖}^{2}} , i = 1 , 2 , … , K ,$$

where λᵢ=1 for data points of retained items and λᵢ=0.1 for data points of returned items.
4. For each size s defined in the size chart, we evaluate the confidence voting weight vᵢ(s) and vₚᵣᵢₒᵣ(s) from each nearby instance xᵢ and the prior:

$${v}_{i} ( s ) = \frac{1}{1 + {( l ( s ) - {l}_{i} )}^{T} {Σ}^{- 1} ( l ( s ) - {l}_{i} )} , i = 1 , 2 , … , K , \\ {v}_{prior} ( s ) = \frac{1}{1 + {( l ( s ) - {l}_{prior} )}^{T} {Σ}_{prior}^{- 1} ( l ( s ) - {l}_{prior} )} ,$$

where 1(s) is the associated garment measurements of size s, Σ=diag(σ_{bust}²,σ_{waist}²,σₕᵢₚ²) (and Σₚᵣᵢₒᵣ=diag(σ_{bust,prior}²,σ_{waist,prior}²,σ_{hip,prior}²)
defines the garment stretching and fitting tolerance on each body dimension.
5. The overall confidence score of size s is evaluated as

$$c ( s ) = \frac{{Σ}_{i = 1}^{K} {w}_{i} {v}_{i} ( s ) + β {v}_{prior} ( s )}{K + β} ,$$

6. Return the size s with the highest confidence score c(s*):s*=arg maxₛc(s).

### 4. A Bayesian Approach for Size Chart Correction and Size Advice

Given the fact the number of data points we observed are usually insufficient to estimate the bias vector for each size as mentioned in Section 2.2, an alternative solution is to use a Bayesian approach to learn probabilistic models for each garment size from both observed body measurements data and a default size chart (i.e., the original size chart defined by the retailer, or a size chart of another well-known brand if the retailer's size chart is unknown) in the sense of maximizing a posterioi. As an interpretation, when many body shape observations are given, the model will be mostly determined by the data, whilst in the other case, the model will be more influenced by the prior, i.e. the original size chart in our context, and has a large uncertainty.

This Bayesian approach also gives a solution for garment size advice, which shows a slightly better performance than the uniform size chart correction approaches mentioned in Section 2.3 when the models are learned by garment type.

4.1. Model Training

In the training stage, for each size mark s of a retailer of a specific garment type, we try to model the body shape distribution of users who bought and retained the garment of such a size (Here, we ignore size label but simply index the sizes as s=1, 2, . . . , S from small to large). We currently assume that this model is subjected to a multivariate Gaussian distribution (but note that the validity of this assumption is arguable as sometimes the body parameters could distributed asymmetrically in the measurements space. The Gaussian assumption is more for the case of formulation and mathematical manipulation).

$$P ( x \vert {ℳ}_{s} ) = 𝒩 ( x ; {μ}_{s} , \frac{1}{c} {Σ}_{s} ) , \qquad ( 16 )$$

where Mₛ stands for the sizing model of size mark s, the random vector x refers to the body measurements of a user who ordered this size; c is the confidence of the data, which is dependent on the retention of the order in our model. In the implementation, we assign c=1 for retention orders and c=0.25 for returned orders.

In real life, most garment retailers use a size chart to define the average body metric for a particular garment size. For example, one retailer specifies that the standard tape measurements of size 12 are bust=93 cm, waist=74 cm, and hips=99 cm. This kind of size grading gives us a strong cue of how the distribution mean μₛ should look like. Mathematically, we can introduce a prior for all the size models Mₛ(s=1, 2, . . . , S). In the model, we introduce two types of size priors: 1) reference size prior, and 2) size interval prior.

For the size label, different retailers could have slightly different measurement definitions. We look at the most commonly used size s_{ref}, called “reference size”, and try to model the variance of this size using a reference size prior as the following multivariate Gaussian distribution:

P( [symbol] _{s,ref}|Ω)= [symbol] (μ_{s,ref}|μ₀,Σ₀), (17)

where Ω generally denotes all the hyper-parameters of the size model; the hyper-parameter μ₀=[μ0,bust,μ0,waist,μ0,hips]^{T} is a guessed average measurement definitions of a reference size, while the variance Σ₀ roughly models the variation of such a reference size among all the retailers. In the implementation, we use an arbitrary well-known retailer's size definition (e.g. Warehouse's size 10), while we set Σ₀=diag(5.3, 12.5, 12.8) cm², which is estimated from the definitions on a common size label of a range of different retailers, including Mary Portas, Js Collections, Barbour, Planet, etc.

In most of retailers' size charts, the intervals of measurement definitions between two adjacent size grading, e.g. size 8 and size 10, or size 10 and size 12, are approximately of equal spacing. This interval on each measurement is usually between 4 to 6 cm. We hence define a prior, i.e. site internal prior, on the measurement difference of two neighbouring sizes to constrain the grading spacings of a size chart. This can also be modelled by a multivariate Gaussian distribution

$$\begin{matrix}P ( {ℳ}_{{s}^{′}} \vert {ℳ}_{s} , Ω ) = 𝒩 ( {μ}_{{s}^{′}} - {μ}_{s} \vert {δ}_{{s}^{′} , s} , {Σ}_{δ} ) \\ = 𝒩 ( {μ}_{{s}^{′}} - {μ}_{s} \vert {δ}_{{s}^{′} , s} , {σ}_{δ}^{2} I ) ,\end{matrix} \qquad ( 18 )$$

where δₛl,ₛ are the default spacings of two neighbouring sizes s^{l} and s and they are set as the intervals of the guessed size charts in the initialization; while the variance Σδ roughly models the potential errors of size spacings, which is assumed to be a spherical Gaussian distribution Σδ=σ²I=diag(0.25, 0.25, 0.25) cm². As a consequence, the generic prior of the Bayesian model P({ [symbol] ₛ [symbol] |Ω) can be factorized as the combination of two types of prior models defined above, as the following equation shows.

$$\begin{matrix}P ( {\{ {ℳ}_{s} \}}_{s = 1}^{S} \vert Ω ) = {\prod }_{s = 1}^{{s}_{ref} - 1} P ( {ℳ}_{s} \vert {ℳ}_{s + 1} , Ω ) \cdot {\prod }_{s = {s}_{ref}}^{S - 1} P ( {ℳ}_{s + 1} \vert {ℳ}_{s} , Ω ) \cdot \\ P ( {ℳ}_{s , ref} \vert Ω ) \\ = ( {\prod }_{s = 1}^{S - 1} 𝒩 ( {μ}_{s + 1} - {μ}_{s} \vert {δ}_{s + 1 , s} , {Σ}_{δ} ) ) \cdot 𝒩 ( {μ}_{s , ref} \vert {μ}_{0} , {Σ}_{0} )\end{matrix} \qquad ( 19 )$$

Now we are also presented with a number of observations from all the sales record X={Xₛ}ₛ₌₁^{S} as the likelihood, where Xₛ={X_{s,i},c_{s,i}}ᵢ₌₁^{N}^{ₛ} denotes the data of all Ns users who ordered size s, including user's body measurements x_{s,i} and the data confidence c_{s,i}. By combining the equations (16), (17), and (18), we can formulate the overall posterior distribution of all the size models {Mₛ}ₛ₌₁^{S} with respect to both the observed data X (i.e. likelihood) and the model priors with hyper-parameters Ω={μ0, Σ₀,{δ_{s,s+1}}ₛ₌₁^{S-1},Σδ}:

$$\begin{matrix}L = P ( {\{ {ℳ}_{s} \}}_{s = 1}^{S} \vert X , Ω ) \\ ∝ P ( X , {\{ {ℳ}_{s} \}}_{s = 1}^{S} \vert Ω ) \\ = ( {\prod }_{s = 1}^{S} P ( {X}_{s} \vert {ℳ}_{s} ) ) P ( {\{ {ℳ}_{s} \}}_{s = 1}^{S} \vert Ω ) \\ = ( {\prod }_{s = 1}^{S} {\prod }_{i = 1}^{{N}_{s}} P ( {x}_{s , i} \vert {ℳ}_{s} ) ) P ( {\{ {ℳ}_{s} \}}_{s = 1}^{S} \vert Ω ) \\ = ( {\prod }_{s = 1}^{S} {\prod }_{i = 1}^{{N}_{s}} 𝒩 ( {x}_{s , i} \vert {μ}_{s} , \frac{1}{{c}_{s , i}} {Σ}_{s} ) ) \cdot \\ P ( {\{ {μ}_{s} \}}_{s = 1}^{S} \vert {μ}_{s , 0} , {Σ}_{s , 0} , {\{ {δ}_{s , s + 1} \}}_{s = 1}^{S - 1} , {Σ}_{δ} ) \\ = ( {\prod }_{s = 1}^{S} {\prod }_{i = 1}^{{N}_{s}} 𝒩 ( {x}_{s , i} \vert {μ}_{s} , \frac{1}{{c}_{s , i}} {Σ}_{s} ) ) \cdot \\ ( {\prod }_{s = 1}^{S - 1} 𝒩 ( {μ}_{s + 1} - {μ}_{s} \vert {δ}_{s + 1 , s} , {Σ}_{δ} ) ) \cdot 𝒩 ( {μ}_{s , ref} \vert {μ}_{0} , {Σ}_{0} )\end{matrix} \qquad ( 20 )$$

To learn a size model Mₛ in the sense of maximizing a posteriori, we need to solve the following optimization problem in (21) over the model parameters μₛ and Σₛ (s=1, 2, . . . , S), so that L in (20) in is maximized.

$$\begin{matrix}{\{ {μ}_{s}^{*} , {Σ}_{s}^{*} \}}_{s = 1}^{S} = arg {max}_{{\{ {μ}_{s} , {Σ}_{s} \}}_{s = 1}^{S}} L = arg {min}_{{\{ {μ}_{s} , {Σ}_{s} \}}_{s = 1}^{S}} - log L \\ = arg {min}_{{\{ {μ}_{s} , {Σ}_{s} \}}_{s = 1}^{S}} {\sum }_{s = 1}^{S} ( \frac{{Σ}_{i = 1}^{{N}_{s}} {c}_{s , i}}{2} log \vert det ( {Σ}_{s} ) \vert ) + \\ \frac{1}{2} {\sum }_{s = 1}^{S} {\sum }_{i = 1}^{{N}_{s}} {{c}_{s , i} ( {x}_{s , i} - {μ}_{s} )}^{T} {Σ}_{s}^{- 1} ( {x}_{s , i} - {μ}_{s} ) + \\ {\sum }_{s = 1}^{S - 1} \frac{{‖ {μ}_{s + 1} - {μ}_{s} - {δ}_{s + 1 , s} ‖}^{2}}{2 {σ}_{δ}^{2}} + \frac{{‖ {μ}_{s , ref} - {μ}_{0} ‖}^{2}}{2 {σ}_{0}^{2}}\end{matrix} \qquad ( 21 )$$

We can solve the optimization problem in (21) and learned the size models Mₛ for all sizes sεS defined for the garment (types) and iterate over all garment types.

4.2. Solve the Optimization in Training

The optimization problem in (21) can be solved by computing the derivatives of L with respect to parameters μₛ and Σₛ, and letting

$$\frac{\partial L}{\partial {μ}_{s}} = 0 and \frac{\partial L}{\partial {Σ}_{s}} = 0 ( s = 1 , 2 , … , S ) .$$

We can have

$$\begin{matrix}\frac{\partial L}{\partial {μ}_{s}} = {\sum }_{i = 1}^{{N}_{s}} {c}_{s , i} {Σ}_{s}^{- 1} ( {x}_{s , i} - {μ}_{s} ) + {u}_{s +} \frac{{μ}_{s} - {μ}_{s + 1} + {δ}_{s , s + 1}}{{σ}_{δ}^{2}} + {u}_{s -} \frac{{μ}_{s} - {μ}_{s - 1} - {δ}_{s - 1 , s}}{{σ}_{δ}^{2}} + {u}_{ref , s} \frac{{μ}_{s} - {μ}_{0}}{{σ}_{0}^{2}} = 0 , & ( 22 ) \\ \begin{matrix} \frac{\partial L}{\partial {Σ}_{s}} = \frac{{Σ}_{i = 1}^{{N}_{s}} {c}_{s , i}}{2} {Σ}_{s}^{- 1} + {\sum }_{i = 1}^{{N}_{s}} {c}_{s , i} {Σ}_{s}^{- 1} ( {x}_{s , i} - {μ}_{s} ) {( {x}_{s , i} - {μ}_{s} )}^{T} {Σ}_{s}^{- 1} \\ = 0 ,\end{matrix} & ( 23 )\end{matrix}$$

where

$${u}_{s +} = \{ \begin{matrix}1 , & s < S - 1 ; \\ 0 , & s = S - 1.\end{matrix} , {u}_{s -} = \{ \begin{matrix}1 , & s > 1 ; \\ 0 , & s = 1.\end{matrix} , and {u}_{s , ref} = \{ \begin{matrix}1 , & s = {s}_{ref} ; \\ 0 , & s \neq {s}_{ref} .\end{matrix}$$

are the indicating parameters. By transforming equations (22) and (23), we can obtain the following set of fixed-point equations:

$$\begin{matrix}{μ}_{s , new} = {( {\sum }_{i = 1}^{{N}_{s}} {c}_{s , i} {Σ}_{s}^{- 1} + ( \frac{{u}_{s +} + {u}_{s -}}{{σ}_{δ}^{2}} + \frac{{u}_{ref , s}}{{σ}_{0}^{2}} ) I )}^{- 1} \cdot ( {\sum }_{i = 1}^{{N}_{s}} {c}_{s , i} {Σ}_{s}^{- 1} {x}_{s , i} + {u}_{s +} \frac{{μ}_{s + 1} - {δ}_{s , s + 1}}{{σ}_{δ}^{2}} + {u}_{s -} \frac{{μ}_{s - 1} + {δ}_{s - 1 , s}}{{σ}_{δ}^{2}} + {u}_{ref , s} \frac{{μ}_{0}}{{σ}_{0}^{2}} ) , & ( 24 ) \\ {Σ}_{s , new} = \frac{1}{{Σ}_{i = 1}^{{N}_{S}} {c}_{s , i}} {\sum }_{i = 1}^{{N}_{s}} {c}_{s , i} ( {x}_{s , i} - {μ}_{s} ) {( {x}_{s , i} - {μ}_{s} )}^{T} . & ( 25 )\end{matrix}$$

By setting initial values μₛ=μ_{s,0} and Σₛ=σ_{s,0}²I(s=1, 2, . . . , S) according to a rough guess, and then iteratively evaluating the equations (24) and (25) above, we can quickly reach the solution of μ* and Σ*ₛ (s=1, 2, . . . , S) that satisfy both (22) and (8). In the implementation, it would be good to slightly regulate the variance matrix in each iteration to avoid singularity during the matrix inversion:

Σₛ=Σₛ+λI, (26)

4.3. Querying and Size Recommendation Through Model Selection

For a user with query body measurements x and provided all the pre-learned size models {Mₛ}sεS of the garment being tried on, we can recommend an optimal size s by means of a model selection, i.e. recommending the size of which the model gives the highest posterior value. Mathematically, this problem is formulated as:

$$\begin{matrix}{s}^{*} = arg {max}_{s} P ( s \vert x , {\{ {ℳ}_{s} \}}_{s ∈ S} ) \\ = arg {max}_{s} P ( x \vert s , {\{ {ℳ}_{{s}^{′}} \}}_{{s}^{′} ∈ S} ) P ( s ) \\ = arg {max}_{s} P ( x \vert {ℳ}_{s} ) P ( s ) \\ = arg {min}_{s} - log P ( x \vert {ℳ}_{s} ) - log P ( s ) \\ = arg {min}_{s} \frac{1}{2} log \vert det ( {Σ}_{s} ) \vert + \frac{1}{2} {( x - {μ}_{s} )}^{T} {Σ}_{s}^{- 1} ( x - {μ}_{s} ) - \\ log ( \frac{{f}_{s}}{{Σ}_{{s}^{′}} {f}_{{s}^{′}}} )\end{matrix} \qquad ( 27 )$$

where

$$P ( s ) = \frac{{f}_{s}}{{Σ}_{{s}^{′}} {f}_{{s}^{′}}}$$

is the prior distribution of size s and which we usually estimate by its frequency among large amount of sales data. The formulation in (27) for evaluation the log-posterior of the size is very similar to the Mahalanobis distance metric in equation (5) of Section 2.2. The difference is that the frequency of the size label is taken into account here.

1. A computer-implemented method, performed using a garment size recommendation and fit analysis system in which a memory stores a virtual profile or model of an end-user and a processor is programmed to receive an end-user's selection of a garment and to then determine, using a garment fit algorithm, how well that garment will fit the end-user's profile or model, and in which the algorithm is trained on actual sales data the method including the steps of:
(i) the system training the garment fit algorithm on actual sales data;
(ii) the processor receiving the end-user's selection of the garment;
(iii) the processor using the trained garment fit algorithm to determine how well that garment will fit the end-user's profile or model, for a plurality of garment sizes, and
(iv) the system recommending to the end-user the best fit or size of the garment.

2. The method of claim 1 in which the algorithm is trained on actual sales data from the retailer of that garment in order to adjust the size charts from that retailer.

3. The method of claim 1 in which the sales data includes one or more of: a list of items purchased in an order; the size(s) of the garment(s) in the order; the body parameters of the customer; the customer's demographic information, location, and fit preference; whether the garment(s) were kept, returned, or exchanged.

4. The method of claim 1, in which the algorithm is trained using, and updated on, actual, live sales data.

5. The method of claim 1, in which the actual, live sales data for a specific retailer is tracked using a widget or application launched when a customer browses the web retail web site of that retailer.

6. The method of claim 1, in which the trained algorithm requires a relatively small amount of initial training data to make it usable, but updates over time to adapt to different body shape groups associated with different garment categories.

7. The method of claim 1, in which the trained algorithm requires a relatively small amount of initial training data to make it usable, but updates over time to adapt to different garment brands under that retailer.

8. The method of claim 1, in which the training algorithm tracks trends in consumer purchasing and returns behaviour.

9. The method of claim 1, in which the trained algorithm operates even when good garment size charts of the retailer or the brand are not available.

10. The method of claim 1, in which the trained algorithm operates when the manufactured item deviates from the size chart.

11. The method of claim 1, in which the trained algorithm generates a visual plot, such as a scatter plot, showing how measurements associated with a retailer's size charts correlates with customers who bought and kept, or bought and returned, a particular size of garment from that retailer.

12. The method of claim 1, in which the profile or model is specific to the end-user and is derived from one or more of: personal data relating to the user; height; weight; age; body shape; cup size; chest/bust, waist and hip measurements; previously bought or liked garments; previous browsing history.

13. The method of claim 1, in which the profile or model is specific to the end-user and hence not a cluster of similar end-users

14. The method of claim 1, in which the trained algorithm compares the virtual profile or model of the end-user with data from the fit-points of the garment retailer's size charts.

15-22. (canceled)

23. The method of claim 1, in which the trained algorithm computes the similarity of the end-user's profile or model and the corresponding measurements of each size of a garment by using a distance metric.

24. The method of claim 23 in which the corresponding measurements of each size of a garment are defined in the size charts from the retailer or manufacturer of that garment.

25. (canceled)

26. The method of claim 23 in which the distance metric is a metric that takes into account correlation between different body measurements, such as the Mahalanobis distance, or in which the distance metric is a metric that takes into account that different fit points have different levels of impact on size recommendation, such as the Mahalanobis distance.

27. (canceled)

28. The method of claim 1, in which the training algorithm uses an estimation of the body shape distribution associated with actual sales and returns of each size of a garment and generates a bias to correct the measurement definition in the size chart.

29. The method of claim 1, in which the training algorithm uses a K-Nearest Neighbour (KNN) machine learning algorithm.

30-31. (canceled)

32. The method of claim 1, in which the training algorithm uses a Bayesian approach to learn probabilistic models for each garment size from observed body measurement data and a default size chart in order to correct the measurement definitions in the size charts.

33. (canceled)

34. The method of claim 1, in which the trained algorithm tells the customer how well a specific size of an item currently being viewed would fit against their virtual profile/model (e.g. their bust, waist and hips), for example using predefined terms or categories.

35. (canceled)

36. The method of claim 1, in which the processor displays an item of a specific size, together with their fitting information with a choose or selection icon (e.g. a tick box) or system (e.g. drag‘n’drop) that, if activated, transfers the or each item into an on-line shopping bag for purchase.

37. The method of claim 1, in which (a) the virtual profile or model is generated from user data; (b) a 3D garment image is generated by analysing and processing multiple 2D photographs of the garment; and (c) the 3D garment image is shown super-imposed over the 3D virtual body model.

38. A computer-implemented garment size recommendation and fit analysis system in which a memory stores a virtual profile or model of an end-user and a processor is programmed to receive an end-user's selection of a garment and to then determine, using a garment fit algorithm, how well that garment will fit the end-user's profile or model, for a plurality of garment sizes, and in which the algorithm is trained on actual sales data wherein the system uses the trained garment fit algorithm to recommend to the end-user the best fit or size of the garment.
